(19) United States
(12) Patent Application Publication
(10) Pub. No.: US 2004/0234266 A1
(43) Pub. Date: Nov. 25, 2004

(54) Reconfigurable add/drop module

(76) Inventors: Sung-Tae Kim, Kyonggi-do (KR); Seong-Taek Hwang, Pyongtaek-shi (KR); Young-Seok Kim, Songnam-shi (KR)

Correspondence Address: CHA & REITER, LLC, 210 ROUTE 4 EAST STE 103, PARAMUS, NJ, 07652, US

(21) Appl. No.: 10/717,055

(22) Filed: Nov. 19, 2003

(30) Foreign Application Priority Data
May 20, 2003 (KR) 2003-32059

(51) Int. Cl. H04J 14/02

(52) U.S. Cl. 398/83

(57) ABSTRACT

An add/drop module is disclosed including a first circulator having first through third ports that are connected to an external optical fiber, the first circulator outputting an optical signal, input to the first port, to the second portand outputting an optical signal, input to the second port, to the third port, an optical multiplexer/demultiplexer having a multiplexing port connected to the second port of the first circulator, and adapted to provide a passage for the optical signal, and a plurality of demultiplexing ports respectively adapted to provide passages for demultiplexed channels associated therewith, and a plurality of add/drop units. Each add/drop unit includes a second circulator having first through third ports, a second port thereof being connected to an associated one of the demultiplexing ports, and an optical switch having first through fourth ports. The first port being connected to the third port of the second circulator, and at the third port to the first port of the second circulator, the first port of the optical switch being selectively connected with or the third port of the optical switch to establish a path for a channel to be passed or with the fourth port of the optical switch to establish a path for a channel to be dropped, the second port of the optical switch being selectively connected with the third port of the optical switch to establish a path for a channel to be added.

### CLAIM OF PRIORITY

This application claims priority to an application entitled “RECONFIGURABLE ADD/DROP MODULE,” filed in the Korean Intellectual Property Office on May 20, 2003 and assigned Ser. No. 2003-32059, the contents of which are hereby incorporated by reference.

### BACKGROUND OF THE INVENTION

1. Field of the Invention

The present invention relates to a wavelength division multiplexing (WDM) optical transmission system, and more particularly to a channel add/drop module for a multiplexed optical signal advancing in the WDM optical transmission system.

2. Description of the Related Art

Conventional metro WDM optical transmission systems have been developed that are capable of adding/dropping an optical signal at each node. Research has been also been conducted into single-fiber bi-directional ring networks. In the architecture of such an optical transmission system, add/drop modules perform a highly important function. Various add/drop modules have been developed to meet various network architectures. For example, a reflection type reconfigurable add/drop module using a single optical multiplexer/demultiplexer has been developed. Typically, this add/drop module consists of circulators, optical switches, and fiber Bragg gratings.

Circulators, used in such an add/drop module, each have a plurality of ports. In the following description and drawings, one circulator is designated by a reference numeral “###”, its m-th port is designated by “m” so that a reference numeral “###m” means the m-th port of the ### circulator.

FIG. 1 is a diagram illustrating the configuration of a conventional reconfigurable add/drop module. As shown in FIG. 1, the add/drop module designated by the reference numeral 100 includes a first circulator 120, that is, CIR1, an optical multiplexer/demultiplexer 130, that is, WGR, and first through n-th add/drop units 140 to 150.

The first circulator 120 has first through third ports 1201 to 1203. The first circulator 120 is connected at its first and third ports 1201 and 1203 to an external optical fiber 110. The first circulator 120 outputs to its second port 1202 an optical signal input to its first port 1201 via the external optical fiber 110, while outputting to its third port 1203 an optical signal input to its second port 1202 via the optical fiber 110. The first circulator 120 is a wavelength-independent element, so that it operates to output an optical signal, inputted to a higher-order port thereof, to a lower-order port thereof arranged adjacent to the higher-order port.

The optical multiplexer/demultiplexer 130 is provided at one side with one multiplexing port 131(MP) and at the other side with a plurality of first through n-th demultiplexing ports 132 to 133(DP1 to DPn). The optical multiplexer/demultiplexer 130 demultiplexes a multiplexed optical signal input to the multiplexing port 131, by units of wavelength, and outputs the resultant demultiplexed channels to the first through n-th demultiplexing ports 132 to 133, respectively. The optical multiplexer/demultiplexer 130 also multiplexes first through n-th channels λ1 to λn, input to respective first through n-th demultiplexing ports 132 to 133 and outputs the resultant multiplexed optical signal to the multiplexing port 131. The multiplexing port 131 is connected to the second port 1202 of the first circulator 120. The optical multiplexer/demultiplexer 130 is also connected at its first through n-th demultiplexing ports 132 to 133 to respective first through n-th add/drop units 140 to 150.

The first through n-th add/drop units 140 to 150 include 1×2 optical switches 141 to 151(SW1 to SWn), fiber Bragg gratings 142 to 152, (FBG1 to FBGn), and circulators 143 to 153 (CIR21 to CIR2n), respectively. The first through n-th add/drop units 140 to 150 have the same configuration. Accordingly, the following description will be given only in conjunction with the first add/drop unit 140.

The SW1 141 is provided at one side with a first port 1411, and at the other side with second and third ports 1412 and 1413. The SW1141 is connected at its first port 1411 to the first demultiplexing port 132, at its second port 1412 to the FBG1 142, and at its third port 1413 to the CER21 143. The first port 1411 of the SW1 141 is selectively connected with the second port 1412 or the third port 1413. The first and second ports 1411 and 1412 of the SW1 141 are connected in a bar state of the SW1 141, whereas the first and third ports 1411 and 1413 are connected in a cross state of the SW1 141.

The FBG1 142 reflects the first channel λ1 corresponding to a predetermined wavelength.

The CIR21 143 has first through ports 1431 to 1433. The CIR21 143 is connected at its second port 1432 to the third port 1413 of the SW1 141. The CIR21 143 outputs the first channel λ1, input to its second port 1432, to its third port 1433, thereby dropping the first channel λ1. The CIR21 143 also outputs another first channel λ1, input to its first port 1431, to its second port 1432, thereby adding the first channel λ1. The CIR21 143 is a wavelength-independent element, so that it operates to output an optical signal, input to a higher-order port thereof, to a lower-order port thereof arranged adjacent to the higher-order port.

Now, operation of the add/drop module 100 will be described in conjunction with a first procedure of passing an optical signal consisting of first through n-th channels λ1 to λn while being input thereto via the external optical fiber 110, and a second procedure of dropping the first channel λ1 from the input optical signal, and then adding a new first channel λ1 to the optical signal.

In the first procedure, the first through n-th optical switches 141 to 151(SW1 to SWn) are controlled to be in their bar state by a control unit (not shown). When an optical signal is input to the first port 1201 of the CIR1 120 in this state, the CIR1 120 outputs the input optical signal to its second port 1202 to which the optical multiplexer/demultiplexer 130 is connected at its multiplexing port 131. The optical multiplexer/demultiplexer 130 demultiplexes the optical signal, input to its multiplexing port 131, in the unit of wavelengths, and outputs the resultant demultiplexed channels to its first through n-th ports 132 to 133, respectively. The SW1 141 of the first add/drop unit 140 receives the first channel λ1 from the optical multiplexer/demultiplexer 130 at its first port 1411, and then outputs the received first channel λ1 to its second port 1412 to which the FBG1 142 is connected. The FBG1 142 reflects the first channel λ1 which is, in turn, re-input to the second port 1412 of the SW1 141. The SW1 141 then outputs the first channel λ1 to its first port 1411. The second to n-th add/drop units operate in the same manner as the first add/drop unit 140. In this way, the first to n-th add/drop units 140 to 150 pass the first to n-th channels λ1 to λn input thereto. The optical multiplexer/demultiplexer 130 receives the first through n-th channels λ1 to λn from the first through n-th add/drop units at its first through n-th demultiplexing ports 132 to 133, multiplexes the first through n-th channels λ1 to λn, and outputs the resultant multiplexed optical signal to its multiplexing port 131 connected to the second port of the first circulator 120. The first circulator 120 then outputs the multiplexed optical signal, input to its second port 1202, to its third port 1203 connected to the external optical fiber 110.

In the second procedure, the control unit controls the SW1 141 to be maintained in its cross state while controlling the remaining optical switches to be maintained in their bar state. When an optical signal is input to the first port 1201 of the CIR1 120 in this state, the CIR1 120 outputs the input optical signal to its second port 1202. The optical multiplexer/demultiplexer 130 demultiplexes the optical signal, input to its multiplexing port 131, in the unit of wavelengths, and outputs the resultant demultiplexed channels to its first through n-th ports 132 to 133, respectively. The SW1 141 receives the first channel λ1 from the optical multiplexer/demultiplexer 130 via first port 1411, and then outputs the received first channel λ1 to its third port 1413 connected to the second port 1432 of the CIR21 143. The CIR21 143 outputs the first channel λ1, input to its second port 1432, to its third port 1433, thereby dropping the first channel λ1. The CIR21 143 receives a first channel λ1 at its first port 1431, and outputs the first channel λ1 to its second port 1432. In this way, the CIR21 143 adds the first channel λ1. The SW1 141 receives the first channel λ1 at its third port 1413, and outputs the received first channel λ1 to its first port 1411. The remaining add/drop units pass the second to n-th channels B2 to λn input thereto, respectively. The optical multiplexer/demultiplexer 130 then receives the first through n-th channels λ1 to λn from the first through n-th add/drop units at its first through n-th demultiplexing ports 132 to 133, multiplexes the first through n-th channels λ1 to λn, and outputs the resultant multiplexed optical signal to its multiplexing port 131 connected to the second port of the first circulator 120. The first circulator 120 then outputs the multiplexed optical signal, input to its second port 1202, to its third port 1203 connected to the external optical fiber 110.

The above mentioned add/drop module 100 is reconfigurable because respective switching operations of the first through n-th optical switches for first through n-th channels λ1 to λn can be varied.

However, each add/drop unit of the conventional add/drop module 100 should be provided with a fiber Bragg grating (or a reflecting element such as a mirror) in order to pass an associated channel. It is also necessary to appropriately set the reflection wavelength of the fiber Bragg grating to meet the wavelength of the associated channel. Since such a fiber Bragg grating is expensive, the manufacturing cost of the add/drop module 100 increases correspondingly. Due to use of such a fiber Bragg grating, the add/drop module also has a complex configuration.

### SUMMARY OF THE INVENTION

One object of the invention is to provide cost effective add/drop module. Another object of the present invention is to provide an add/drop module having a simplified configuration, as compared to the conventional modules discussed above.

One embodiment of the present invention is directed to an add/drop module including a first circulator having first through third ports that are connected to an external optical fiber. The first circulator outputs an optical signal, input to the first port, to the second port, while outputting an optical signal, input to the second port, to the third port. The module also includes an optical multiplexer/demultiplexer having a multiplexing port connected to the second port of the first circulator, and adapted to provide a passage for the optical signal, and a plurality of demultiplexing ports respectively adapted to provide passages for demultiplexed channels associated therewith, and a plurality of add/drop units. Each add/drop unit includes a second circulator having first through third ports that are connected at the second port thereof to an associated one of the demultiplexing ports, the second circulator outputs a channel, input to the second port, to the third port while outputting a channel, input to the first port, to the second port, and an optical switch having first through fourth ports that are connected at the first port to the third port of the second circulator, and at the third port to the first port of the second circulator, the first port of the optical switch being selectively connected with or the third port of the optical switch to establish a path for a channel to be passed or with the fourth port of the optical switch to establish a path for a channel to be dropped, the second port of the optical switch being selectively connected with the third port of the optical switch to establish a path for a channel to be added.

### BRIEF DESCRIPTION OF THE DRAWINGS

The above objects and advantages of the present invention will become more apparent by describing in detail preferred embodiments thereof with reference to the attached drawings in which:

FIG. 1 is a diagram illustrating the configuration of a conventional reconfigurable add/drop module; and

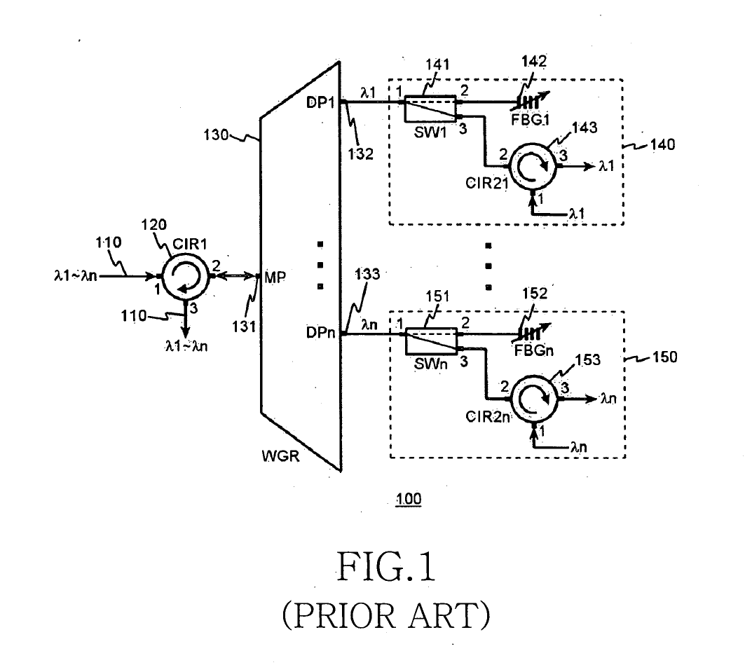

FIG. 2 is a diagram illustrating the configuration of a reconfigurable add/drop module according to the present invention.

### DETAILED DESCRIPTION OF THE PREFERRED EMBODIMENT

Now, preferred embodiments of the present invention will be described in detail with reference to the drawings. In the following description, a detailed description of known functions and configurations incorporated herein will be omitted when it may obscure the subject matter of the present invention.

One embodiment of the present invention provides a reconfigurable add/drop module using circulators, and optical switches. Each of the circulators and optical switches has a plurality of ports. In the following description, one circulator or optical switch is designated by a reference numeral “###”, its m-th port is designated by “m” so that so that a reference numeral “###m” (e.g., 1115) means the m-th port of the ## circulator or optical switch.

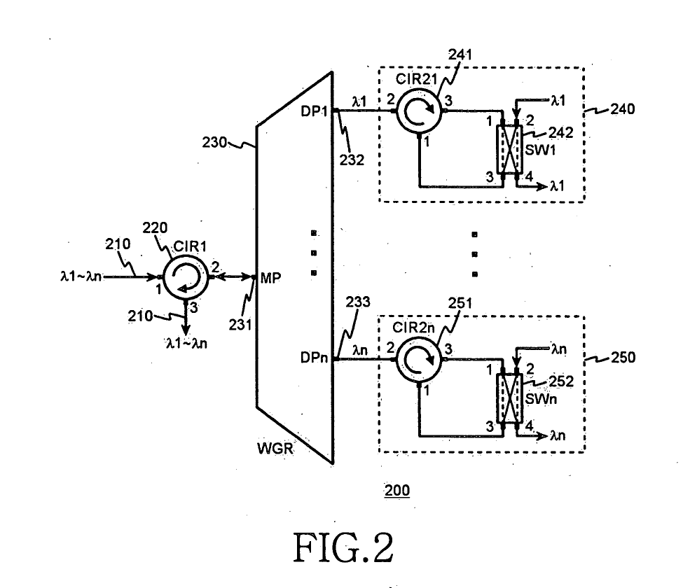

FIG. 2 is a diagram illustrating the configuration of a reconfigurable add/drop module according to one embodiment of the present invention. As shown in FIG. 2, a reconfigurable add/drop module 200 includes a first circulator 220(CIRl), an optical multiplexer/demultiplexer 230 (WGR) and first through n-th add/drop units 240 to 250.

The first circulator 220 has first through third ports 2201 to 2203. The first circulator 220 is connected at its first and third ports 2201 and 2203 to an external optical fiber 210. The first circulator 220 outputs to its second port 2202 an optical signal input to its first port 2201 via the external optical fiber 210. The first circulator 220 also outputs to its third port 2203 an optical signal input to its second port 2202 via the optical fiber 210. The first circulator 220 is a wavelength-independent element, so that it operates to output an optical signal, input to a higher-order port thereof, to a lower-order port thereof arranged adjacent to the higher-order port.

The optical multiplexer/demultiplexer 230 is provided at one side with one multiplexing port 231 (MP) and at the other side with a plurality of first through n-th demultiplexing ports 232 to 233 (DP1 to DPn). The optical multiplexer/demultiplexer 230 demultiplexes a multiplexed optical signal, input to the multiplexing port 231, in units of wavelength, and outputs the resultant demultiplexed channels to the first through n-th demultiplexing ports 232 to 233, respectively. The optical multiplexer/demultiplexer 230 also multiplexes first through n-th channels λ1 to λn, input to respective first through n-th demultiplexing ports 232 to 233, and outputs the resultant multiplexed optical signal to the multiplexing port 231. The multiplexing port 231 of the optical multiplexer/demultiplexer 230 is connected to the second port 2202 of the first circulator 220. The optical multiplexer/demultiplexer 230 is also connected at its first through n-th demultiplexing ports 232 to 233 to respective first through n-th add/drop units 240 to 250. The optical multiplexer/demultiplexer 230 may include a 1×n waveguide grating router (WGR) integrated on a semiconductor substrate.

The first through n-th add/drop units 240 to 250 include circulators 241 to 251 (CR21 to CIR2n) and 2×2 optical switches 242 to 252 (SW1 to SWn), respectively. The first through n-th add/drop units 240 to 250 have the same configuration. In view of this, the following description will be given only in conjunction with the first add/drop unit 240.

The first add/drop unit 240 includes the CIR21 241 and the SW1 242.

The CIR21 241 has first through ports 2411 to 2413. The CIR21 241 is connected at its second port 2412 to the first demultiplexing port 232, DP1, of the optical multiplexer/demultiplexer 230. The CIR21 241 outputs the first channel λ1, input to its second port 2412, to its third port 2413, and outputs another first channel λ1, input to its first port 2411, to its second port 2412. The CIR21 241 is a wavelength-independent element, so that it operates to output an optical signal, input to a higher-order port thereof, to a lower-order port thereof arranged adjacent to the higher-order port.

The SW1 242 is provided at one side with first and second ports 2421 and 2422, and at the other side with third and fourth ports 2423 and 2424. The SW1 242 is connected at its first port 2421 to the third port 2413 of the CIR21 241, and at its third port to the first port 2411 of the CIR21 241. The first port 2421 of the SW1 242 is selectively connected with the third port 2423 to establish a channel passing path or with fourth port 2424 to establish a channel dropping path. When the SW1 242 is in its bar state, its first and third ports 2421 and 2423 are connected to each other, and its second and fourth ports 2422 and 2424 are connected to each other. On the other hand, when the SW1 242 is in its cross state, its first and fourth ports are connected to each other, and its second and third ports 2422 and 2423 are connected to each other.

Now, operation of the add/drop module 200 will be described in conjunction with a first/procedure of passing an optical signal consisting of first through n-th channels λ1 to λn while being input thereto via the external optical fiber 210, and a second procedure of dropping the first channel λ1 from the input optical signal, and then adding a new first channel λ1 to the optical signal.

In the first procedure, the first through n-th optical switches 242 to 252 (SW1 to SWn) are controlled to be in their bar state by a control unit (not shown). When an optical signal is input to the first port 2201 of the CIR1 220 in this state, the CIR1 220 outputs the input optical signal to its second port 2202 to which the optical multiplexer/demultiplexer 230 is connected at its multiplexing port 231. The optical multiplexer/demultiplexer 230 demultiplexes the optical signal, input to its multiplexing port 231, in units of wavelength, and outputs the resultant demultiplexed channels to its first through n-th ports 232 to 233, respectively. The CIR21 241 receives the first channel λ1 from the optical multiplexer/demultiplexer 230 at its second port 2422, and then outputs the received first channel λ1 to its third port 2423 to which the SW1 242 is connected at its first port 2421. The SW1 242 outputs the first channel λ1, input to its first port 2421, to its third port 2423 connected to the first port 2411 of the CIR21 241. The CIR21 241 then outputs the first channel λ1, input to its first port 2411, to its second port 2412. The second to n-th add/drop units operate in the same manner as the first add/drop unit 240. In this way, the first to n-th add/drop units 240 to 250 pass the first to n-th channels λ1 to λn input thereto.

The optical multiplexer/demultiplexer 230 receives the first through n-th channels ), to λn from the first through n-th add/drop units at its first through n-th demultiplexing ports 232 to 233, multiplexes the first through n-th channels λ1 to λn, and outputs the resultant multiplexed optical signal to its multiplexing port 231 connected to the second port 2202 of the first circulator 220. The first circulator 220 then outputs the multiplexed optical signal, input to its second port 2202, to its third port 2203 connected to the external optical fiber 210.

In the second procedure, the control unit controls the SW1 242 to be maintained in its cross state while controlling the remaining optical switches to be maintained in their bar state. When an optical signal is input to the first port 2201 of the CIR1 220 in this state, the CIR1 220 outputs the input optical signal to its second port 2202. The optical multiplexer/demultiplexer 230 demultiplexes the optical signal, input to its multiplexing port 231, in units of wavelength, and outputs the resultant demultiplexed channels to its first through n-th ports 232 to 233, respectively. The CIR21 241 of the first add/drop unit 240 receives the first channel λ1 from the optical multiplexer/demultiplexer 230 at its second port 2422, and then outputs the received first channel λ1 to its third port 2423 to which the SW1 242 is connected at its first port 2421. The SW1 242 outputs the first channel λ1, input to its first port 2421, to its fourth port 2424, thereby dropping the first channel λ1. The CIR21 241 then receives a first channel λ1 at its second port 2422, and outputs the received first channel λ1 to its third port 2423. In this way, the CIR21 241 adds of the first channel λ1. The CIR21 241 receives the first channel λ1 from the SW1 242 at its first port 2411, and outputs the received first channel λ1 to its second port 2422. On the other hand, the remaining add/drop units pass the second to n-th channels λ2 to λn input thereto, respectively.

The optical multiplexer/demultiplexer 230 receives the first through n-th channels λ1 to λn from the first through n-th add/drop units 240 to 250 at its first through n-th demultiplexing ports 232 to 233, multiplexes the first through n-th channels λ1 to ?n, and outputs the resultant multiplexed optical signal to its multiplexing port 231 connected to the second port 2202 of the first circulator 220. The first circulator 220 then outputs the multiplexed optical signal, inputted to its second port 2202, to its third port 2203 connected to the external optical fiber 210.

As apparent from the above description, embodiments of the present invention provide a reconfigurable add/drop module in which add/drop units are configured using circulators and optical switches without the need for any reflectors. Such aspects of the present invention a low for reconfigurable add/drop module that has a simple and cost-effective configuration, as compared to conventional modules.

While this invention has been described in connection with what is presently considered to be the most practical and preferred embodiment, it is to be understood that the invention is not limited to the disclosed embodiment, but, on the contrary, it is intended to cover various modifications within the spirit and scope of the appended claims.

What is claimed is:

1. An add/drop module connected to an optical signal for transmitting a multiplexed optical signal in a wavelength division multiplexing optical transmission system, and adapted to add drop a channel for the optical signal, comprising:
a first circulator having first through third ports that are both connected to an optical fiber, the first circulator outputting an optical signal, input to the first port, to the second port, and outputting an optical signal, input to the second port, to the third port;
an optical multiplexer/demultiplexer having a multiplexing port connected to the second port of the first circulator, and adapted to provide a passage for the optical signal, and a plurality of demultiplexing ports respectively adapted to provide passages for demultiplexed channels of the optical signal; and
a plurality of add/drop units each including
a second circulator having first through third ports, a second port of the second circulator being connected to an associated one of the demultiplexing ports, the second circulator outputting a channel, input to the second port, to the third port and outputting a channel, input to the first port, to the second port, and
an optical switch having first through fourth ports while being connected at the first port to the third port of the second circulator, and at the third port to the first port of the second circulator, the first port of the optical switch being selectively connected either the third port of the optical switch to establish a path for a channel to be passed or the fourth port of the optical switch to establish a path for a channel to be dropped, the second port of the optical switch being selectively connected with the third port of the optical switch to establish a path for a channel to be added.

2. The add/drop module according to claim 1, wherein the optical multiplexer/demultiplexer comprises a waveguide grating router.

3. An add/drop module for a wavelength division multiplexing optical transmission system, comprising:
a first circulator having a plurality of ports, the first circulator being connected to an optical fiber;
an optical multiplexer/demultiplexer connected to the first; and
at least two add/drop units each including
a second circulator having a plurality of ports, at least one port being connected to a demultiplexing port of the optical multiplexer/demultiplexer, and
an optical switch having a plurality of ports, two ports being connected to respective ports of the second circulator, another port of the optical switch being selectively connectable to either establish a path for a channel to be passed or to establish a path for a channel to be dropped.

4. The add/drop module according to claim 3, wherein the add/drop unit also include a further port of the optical switch that is selectively connectable to establish a path for a channel to be added.

5. The add/drop module according to claim 3, wherein the optical multiplexer/demultiplexer comprises a waveguide grating router.

6. The add/drop module according to claim 3, wherein the first circulator includes first through third ports that are both connected to the optical fiber, the first circulator outputting an optical signal, input to the first port, to the second port, and outputting an optical signal, input to the second port, to the third port.

7. The add/drop module according to claim 3, wherein the optical multiplexer/demultiplexer includes a multiplexing port connected to the second port of the first circulator, and adapted to provide a passage for the optical signal, and a plurality of demultiplexing ports respectively adapted to provide passages for demultiplexed channels of the optical signal.

8. The add/drop module according to claim 6, wherein the second circulator includes first through third ports, a second port of the second circulator being connected to an associated one of the demultiplexing ports, the second circulator outputting a channel, input to the second port, to the third port and outputting a channel, input to the first port, to the second port.

9. An add/drop unit for an add/drop module for a wavelength division multiplexing optical transmission system, the add/drop unit comprising:
a circulator having a plurality of ports, at least one port being connectable to a demultiplexing port of an optical multiplexer/demultiplexer, and
an optical switch having a plurality of ports, two ports being connected to respective ports of the second circulator, another port of the optical switch being selectively connectable to either establish a path for a channel to be passed or to establish a path for a channel to be dropped.

10. The add/drop module according to claim 9, wherein the add/drop unit also include a further port of the optical switch that is selectively connectable to establish a path for a channel to be added.

11. The add/drop module according to claim 10, wherein the circulator includes first through third ports, a second port of the second circulator being connected to the demultiplexing port, the second circulator outputting a channel, input to the second port, to the third port and outputting a channel, input to the first port, to the second port.
